(19) United States
(12) Patent Application Publication
(10) Pub. No.: US 2010/0259345 A1
(43) Pub. Date: Oct. 14, 2010

(54) METAMATERIAL STRUCTURE HAVING NEGATIVE PERMITTIVITY, NEGATIVE PERMEABILITY, AND NEGATIVE REFRACTIVITY

(75) Inventors: Dongho Kim, Daejeon-City (KR); Wangjoo Lee, Daejeon-city (KR); Jae-Ick Choi, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-city (KR)

(21) Appl. No.: 12/808,106

(22) PCT Filed: Nov. 26, 2008
(86) PCT No.: PCT/KR2008/006950

§ 371 Date: Jun. 14, 2010

(30) Foreign Application Priority Data
Dec. 14, 2007 (KR) 10-2007-0131029

(51) Int. Cl. H01P 3/18

(52) U.S. Cl. 333/239

(57) ABSTRACT

Provided is an unlimited single-layer metamaterial structure having negative permittivity and negative permeability in a frequency bandwidth desired by a user. The metamaterial structure includes: a dielectric having a single layer structure having a permittivity or a multi-layer structure in which at least one layer has a different permittivity; and a single conductor disposed in the dielectric, wherein the metamaterial structure has a permittivity, a permeability, and a refractivity that have 0 or a negative value in a predetermined frequency band.

### TECHNICAL FIELD

The present invention relates to a metamaterial, and more particularly to, a metamaterial structure having negative refractivity in a natural state and using a general medium such as a conductor and a dielectric.

### BACKGROUND ART

Refractivity is the square root of a value obtained from the multiplication of permittivity and permeability. Materials always have positive values in a general natural system. Metamaterials are specific types of materials which have a permittivity of positive value, 0, or negative value, a negative permeability, or a negative refractivity. In more detail, refractivity varies according to frequencies. Metamaterials may have a 0 or negative refractivity in a specific frequency band.

Reversal of Snell's law, reversal of the Doppler effect, a negative phase velocity, and the like, based on the physical characteristics of metamaterials, are widely known.

Although it is widely known that a negative permittivity of a material such as plasma can be obtained from a natural system, a method of obtaining a negative permeability is disclosed after Professor J. B. Pendry, published his paper in 1999, about a Swiss roll or a split ring resonator (SRR) in. Much research has been conducted to obtain metamaterials owing to Pendry's paper. Metamaterials having a refractivity of a positive value, 0, and a negative value have been manufactured. It has been verified from experiments that the refractivity has the positive value, 0, and the negative value.

Metamaterials are a combination of a wire structure, to obtain a negative permittivity, and an SRR structure, to obtain a negative permeability, which is the main method of realizing the development of a metamaterial structure. Although cells in the shape of Ω are turned upside down and face each other in order to have negative permittivity and permeability by only using a geometrical structure, the metamaterial structure formed of cells facing each other have a multi-layer structure.

### DISCLOSURE OF INVENTION

### Technical Problem

The present invention provides a metamaterial structure having a negative permittivity or a permittivity that equals 0, a negative permeability, or a negative refractivity by using a metamaterial that does not exist in nature as a general medium such as a conductor and a dielectric. The present invention also provides an unlimited single-layer metamaterial structure having negative permittivity and negative permeability in a frequency bandwidth desired by a user.

### Technical Solution

According to an aspect of the present invention, there is provided a metamaterial structure comprising: a dielectric having a single layer structure having a permittivity or a multi-layer structure in which at least one layer has a different permittivity; and a single conductor disposed in the dielectric, wherein the metamaterial structure has a permittivity, a permeability, and a refractivity that have 0 or a negative value in a predetermined frequency band.

The conductor may have a plate structure that is horizontally disposed in the dielectric.

The dielectric may have a cuboid structure, and wherein the conductor has a cuboid plate structure and is disposed a predetermined distance from each surface of the dielectric.

The conductor may have an X-shaped plate structure that is horizontally disposed in the dielectric.

The dielectric may have a multi-layer structure including two or more layers, wherein the multi layers have a different permittivity.

The conductor may be formed on the same layer as any one of the layers of the dielectric.

According to another aspect of the present invention, there is provided a metamaterial structure, comprising: a dielectric having a single layer structure having a permittivity or a multi-layer structure in which at least one layer has a different permittivity; and at least two conductors disposed in the dielectric on a same plane, wherein the metamaterial structure has a permittivity, a permeability, and a refractivity that have 0 or a negative value in a predetermined frequency band.

Each of the at least two conductors may have a plate structure that is horizontally disposed in the dielectric.

The number of the conductors may be two, wherein the two conductors have a same or different plate structure.

The dielectric may have a cuboid structure, wherein the two conductors have a same cuboid plate structure, wherein each of the two conductors is disposed a predetermined distance from each surface of the dielectric, and is disposed symmetrically to a centerline of the dielectric.

The dielectric may have a cuboid structure, wherein the two conductors have the same structure comprising a ribbon type plate structure having a predetermined width in which a convex part is formed in the center part of each conductor, the convex part being formed in an outer direction of the dielectric by folding each conductor four times, wherein each of the two conductors is disposed a predetermined distance from each surface of the dielectric, and is disposed symmetrically to a centerline of the dielectric.

The dielectric may have a multi-layer structure having two or more layers, wherein each of the layers has at least two permittivities or the layers has different permittivities.

Each conductor may be formed on a same layer as any one of the layers of the dielectric.

According to another aspect of the present invention, there is provided a metamaterial structure array, comprising the metamaterial structure of claim 9 as a single unit cell.

A plurality of conductors may be upper and lower and left and right disposed in a single dielectric sheet.

A plurality of dielectric sheets in which the plurality of conductors are disposed may be stacked.

The number of the conductors disposed in the dielectric sheets may be adjusted to form a wedge or pyramid structure.

### ADVANTAGEOUS EFFECTS

The metamaterial structure based on a single layer structure can include a conductor and a dielectric, can be a single layer structure, and can obtain permittivity, permeability, and refractivity having a positive value, 0, or a negative value in a desired frequency bandwidth, so that the permittivity, permeability, refractivity, and impedance can be adjusted, thereby controlling a basic physical property such as the size, wavelength, phase, polarization of a signal, etc. in all application fields using an electromagnetic wave according to a user's intention.

The metamaterial structure according to the present invention can be utilized as a source technology in a variety of fields such as, phase compensation of a signal, size reduction and performance improvement of an antenna, a high performance high resolution electronic device for recognizing a subwavelength object in a near-field region, or a far-field region, and a high performance magnetic resonance imaging (MRI) sensor based on a high permeability.

### DESCRIPTION OF DRAWINGS

The above and other features and advantages of the present invention will become more apparent by describing in detail exemplary embodiments thereof with reference to the attached drawings in which:

FIGS. 1A and 1B are perspective and cross-sectional views, respectively, of a metamaterial structure having a negative permittivity and a negative permeability according to an embodiment of the present invention;

FIG. 1C is a cross-sectional view of a metamaterial structure having a negative permittivity and a negative permeability according to another embodiment of the present invention;

FIGS. 2A and 2B are perspective and cross-sectional views, respectively, of a metamaterial structure having a negative permittivity and a negative permeability according to another embodiment of the present invention;

FIG. 2C is a cross-sectional view of a metamaterial structure having a negative permittivity and a negative permeability according to another embodiment of the present invention;

FIGS. 3A and 3B are plan and cross-sectional views, respectively, of a metamaterial structure having a negative permittivity and a negative permeability according to another embodiment of the present invention;

FIG. 4 is a photo of an experiment verifying a negative refractivity with regard to the metamaterial structure shown in FIG. 3A;

FIG. 5 is a graph illustrating the characteristics of an eigen mode with respect to the metamaterial structure shown in FIG. 3A;

FIGS. 6A through 6D are graphs illustrating electrical characteristic parameters with respect to the metamaterial structure shown in FIG. 3A;

FIG. 7 is another photo of an experiment verifying a negative refractivity with regard to the metamaterial structure shown in FIG. 3A;

FIGS. 8A and 8B are plan and cross-sectional views, respectively, of a metamaterial structure having a negative permittivity and a negative permeability according to another embodiment of the present invention;

FIGS. 9A and 9B are plan and cross-sectional views, respectively, of a metamaterial structure having a negative permittivity and a negative permeability according to another embodiment of the present invention;

FIGS. 10A and 10B are plan and cross-sectional views, respectively, of a metamaterial structure having a negative permittivity and a negative permeability according to another embodiment of the present invention;

FIG. 11 is a perspective view of a metamaterial structure array according to an embodiment of the present invention;

FIGS. 12A through 12E and 13A through 13D are plan views of conductors applied to the metamaterial structure shown in FIG. 1A;

FIGS. 14A through 14E and 15A through 15f are plan views of conductors applied to the metamaterial structure shown in FIG. 2A; and

FIG. 16 is a graph illustrating an adjustment of a frequency band having a negatively refractive metamaterial structure by adjusting each parameter shown in FIGS. 3A and 3B.

### BEST MODE

The present invention relates to a single-layer metamaterial structure having a negative permittivity and a negative permeability in a frequency bandwidth desired by a user and a method of designing and manufacturing the metamaterial structure. A metamaterial of the present invention comprises a dielectric and a conductor. The present invention includes a dielectric formed of a single material or a composite material and having a single-layer structure or a multi-layer structure. Furthermore, the present invention includes all conductors having conductivity and including a composite material and a general electric conductor as well.

Unlike the conventional metamaterial structures in which conductor patterns are disposed in both surfaces of the dielectric in order to obtain the negative permittivity and the negative permeability, the metamaterial of the present invention can obtain both the negative permittivity and the negative permeability by only using a single conductor pattern. Therefore, an applicable region of a future metamaterial and manufacturing convenience can be greatly increased.

Hereinafter, the present invention will be described more fully with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, lengths and sizes of layers and regions may be exaggerated for clarity.

It will be understood that when an element is referred to as being ‘on’ or ‘below’ another element, the element can be directly on or below another element or intervening elements. Like numbers refer to like elements throughout.

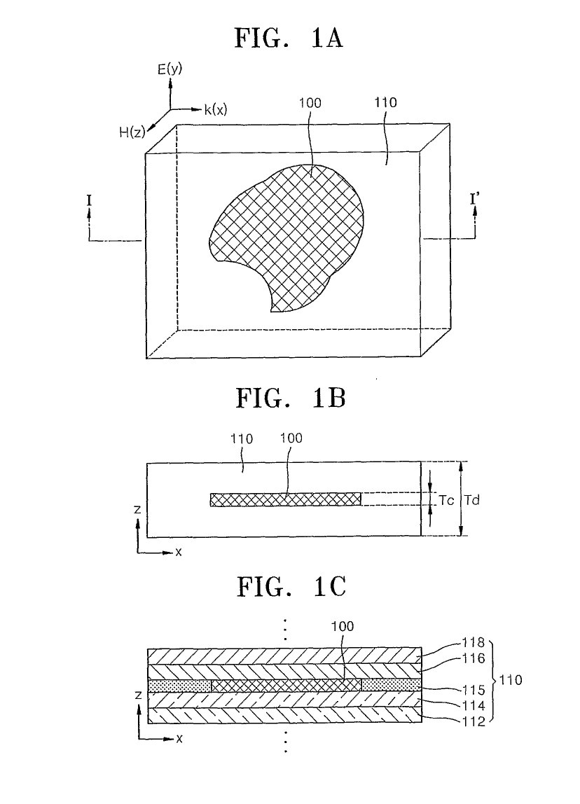

FIGS. 1A and 1B are perspective and cross-sectional views, respectively, of a metamaterial structure having a negative permittivity and a negative permeability according to an embodiment of the present invention. Referring to FIG. 1A, the metamaterial structure of the present embodiment comprises a dielectric 110 and a conductor 100. The conductor 100 is disposed in the dielectric 110 and is not limited to the shape illustrated in FIG. 1A. In more detail, the shape and size of the conductor 100 can be adjusted so that the metamaterial structure has a negative permittivity, a negative permeability, and a negative refractivity in a desired frequency bandwidth. Any one of the permittivity and the permeability can be negative.

The conductor 100 is in the shape of a plate and is horizontally disposed in the dielectric 110 in a direction k(x) in which the electromagnetic wave moves. E(y) and H(z) denote an electric field and a magnetic field of the electromagnetic wave. The conductor 100 is disposed in the dielectric 100 so that the metamaterial structure serves as a resonator with respect to a corresponding frequency band and has the negative refractivity. Although the dielectric 110 is in the shape of a cuboid, the shape of the dielectric 110 is not limited thereto.

Referring to FIG. 1B, which illustrates a cross-sectional view of the metamaterial structure of FIG. 1A taken along the line I-I′, the conductor 100 is disposed in the dielectric 110 in the direction in which the electromagnetic wave moves, i.e., horizontally in a direction x. A relative permittivity ∈ᵣ of the dielectric 110 surrounding the conductor 100 is very important in forming the metamaterial structure. Also, the structure and the size of the conductor 100 and the dielectric 110 are important. For example, the thickness Td of the dielectric 110 and the thickness Tc of the conductor 100 relative to the thickness Td of the dielectric 110 are important factors.

FIG. 1C is a cross-sectional view of a metamaterial structure having a negative permittivity and a negative permeability according to another embodiment of the present invention. Referring to FIG. 1C, the metamaterial structure of the present embodiment may comprise the dielectric 110 having a multi-layer structure having a different permittivity. In more detail, the dielectric 110 may have a plurality of layers comprising a first dielectric layer 112 having a first dielectric ∈ᵣ₁, a second dielectric layer 114 having a second dielectric ∈ᵣ₂, a third dielectric layer 115 having a third dielectric ∈ᵣ₃, a fourth dielectric layer 116 having a fourth dielectric ∈ᵣ₄, and a fifth dielectric layer 118 having a fifth dielectric ∈ᵣ₅. The conductor 100 is in the same layer as the third dielectric layer 115.

Although the dielectric 110 may include a plurality of dielectric layers each having a different permittivity, the dielectric 110 may include dielectric layers having the same permittivity except for adjacent dielectric layers. Each dielectric layer may have the same or different thickness. The conductor 100 may be a layer other than a center layer. The thickness of the conductor 100 may be different from that of the dielectric layer. In conclusion, the permittivity of the dielectric 110 and the structure and size of the dielectric 110 and the conductor 100 of the metamaterial structure may be properly adjusted according to a frequency bandwidth within which the negative refractivity is realized.

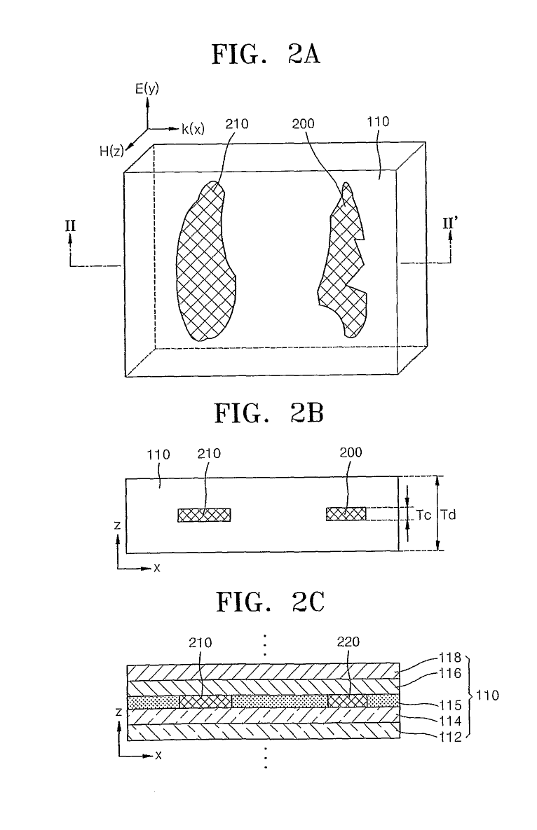

FIGS. 2A and 2B are perspective and cross-sectional views, respectively, of a metamaterial structure having a negative permittivity and a negative permeability according to another embodiment of the present invention. Referring to FIG. 2A, the metamaterial structure of the present embodiment comprises a dielectric 110 and two conductors 200 and 210. The two conductors 200 and 210 are disposed in the dielectric 110 and are not limited to the shape illustrated in FIG. 2A, in the same manner as described with reference to FIGS. 1A through 1C. In more detail, the shape and size of the two conductors 200 and 210 can be adjusted so that the metamaterial structure has a negative permittivity, a negative permeability, and a negative refractivity in a desired frequency bandwidth.

The two conductors 200 and 210 are in the shape of a plate and are horizontally disposed in the dielectric 110 in a direction k(x) in which the electromagnetic wave moves. The two conductors 200 and 210 are disposed in the dielectric 110 so that the metamaterial structure serves as a resonator and thus the characteristics of the negative refractivity can be realized in a broad frequency bandwidth or various frequency bandwidths. Although the two conductors 200 and 210 are used in the present embodiment, two or more conductors can be used if occasion demands.

Referring to FIG. 2B, which illustrates a cross-sectional view of the metamaterial structure of FIG. 2A taken along the line II-II′, the two conductors 200 and 210 are disposed in the dielectric 110 in the direction in which the electromagnetic wave moves, i.e., horizontally in a direction x. The structure and the size of the two conductors 200 and 210 are important in that the metamaterial structure having the two conductors 200 and 210 can realize the characteristics of the negative refractivity.

Meanwhile, the two conductors 200 and 210 are formed in the same layer, so that the metamaterial structure is a structure having single layer conductors in a wide concept. As described with reference to FIGS. 1A through 1C, a relative permittivity of the dielectric 110 surrounding the two conductors 200 and 210, the thickness Tc of the two conductors 200 and 210, and the thickness Td of the dielectric 110 are important.

FIG. 2C is a cross-sectional view of a metamaterial structure having a negative permittivity and a negative permeability according to another embodiment of the present invention. The metamaterial structure having two conductors may include the dielectric 110 having a multi-layer structure. In more detail, the dielectric 110 may have a plurality of layers comprising a first dielectric layer 112, a second dielectric layer 114, a third dielectric layer 115, a fourth dielectric layer 116, and a fifth dielectric layer 118. The two conductors 200 and 210 are in the same layer as the third dielectric layer 115.

The permittivity and the thickness of each dielectric layer of the dielectric 110 having the multi-layers, and the location and the thickness of the two conductors 200 and 210 are the same as described with reference to FIGS. 1A through 1C. In more detail, the permittivity of the dielectric 110 and the structure and size of the dielectric 110 and the two conductors 200 and 210 of the metamaterial structure may be properly adjusted according to a frequency bandwidth within which the negative refractivity is realized.

The metamaterial structures shown in FIGS. 1A and 2A are different from each other in the number of conductors disposed in each cell used to have a negative permittivity or a negative permeability. In more detail, a single layer conductor is disposed in a dielectric in FIG. 1A, whereas two conductors having the same shape or different shapes are disposed in the cell. A user may freely select any one of the conductors shown in FIGS. 1A and 2A according to an overall size of the cell, a range or a bandwidth of frequencies, etc. used to obtain the negative permittivity or the negative permeability.

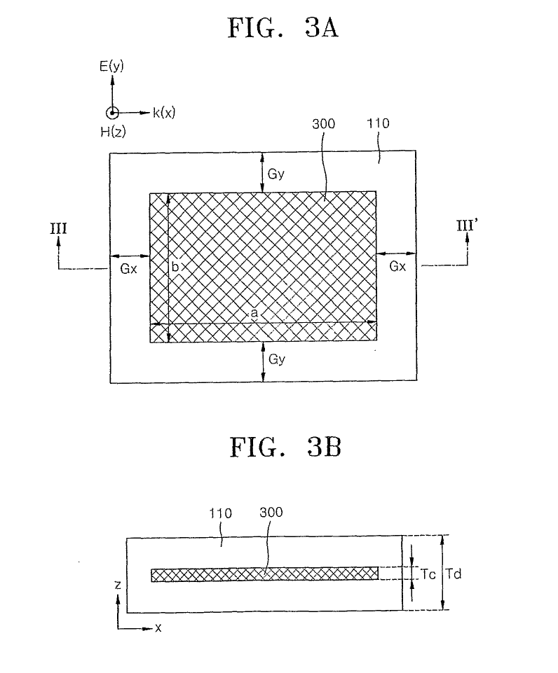

FIGS. 3A and 3B are plan and cross-sectional views, respectively, of a metamaterial structure having a negative permittivity and a negative permeability according to another embodiment of the present invention, and in particular, are for explaining in more detail the structure of a dielectric 110 and a conductor 300.

Referring to FIG. 3A, the metamaterial structure of the present embodiment is based on a single conductor shown in FIGS. 1A through 1C and comprises, for example, a single plate resonator (SPR).

The dielectric 110 is in the shape of a cuboid. The conductor 300 is in the shape of a plate cuboid. The conductor 300 is disposed in the center of the dielectric 110 and is spaced apart from each surface of the dielectric 110 by predetermined distances Gx and Gy. The conductor 300 is symmetrically disposed with regard to the center line of the dielectric 110 so that the horizontal a, the vertical b, and the thickness Tc thereof are adjusted according to a frequency band within which the negative refractivity is realized. The permittivity, the thickness Td, and the distances Gx and Gy of the dielectric 110 are adjusted according to the frequency band.

Referring to FIG. 3B illustrating a cross-sectional view of the metamaterial structure of FIG. 3A taken along the line III-III', a specific value of each parameter is indicated in Table 1. Meanwhile, although the shape of the dielectric 110 and the conductor 300 is a cuboid, the dielectric 110 and the conductor 300 are not limited thereto.

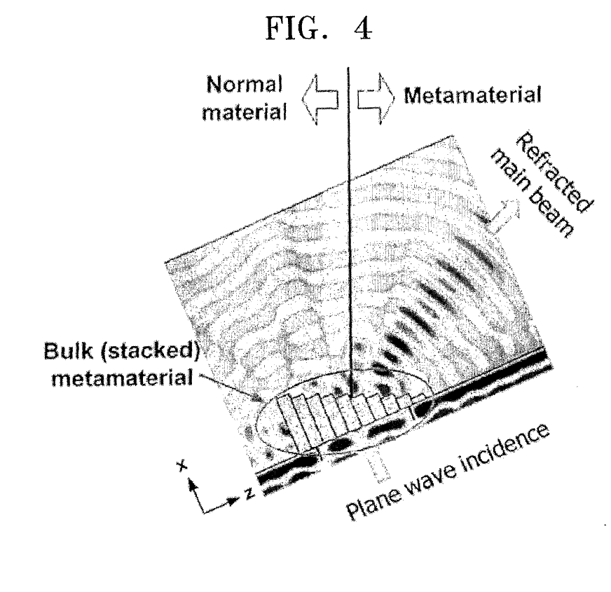

FIG. 4 is a photo of an experiment verifying a negative refractivity with regard to the metamaterial structure shown in FIG. 3A. Referring to FIG. 4, the metamaterial structure indicated by a bulk (i.e., stacked meta-material) comprises a plurality of conductors disposed in a single dielectric plate by using a single unit cell of FIG. 3A where a plurality of the dielectric plates are formed in the shape of a wedge or a pyramid. This metamaterial structure will be described in detail with reference to FIG. 11.

The experiment obtains a result by performing a computer simulation in which a plane wave is incident to the metamaterial structure and a refraction substantially occurs in a negative direction according to Snell's law. If an electromagnetic wave is refractive to the right of a black line, a metamaterial has a negative refractivity. If the electromagnetic wave is refractive to the left of the black line, a general material has a positive refractivity. If the electromagnetic wave is refractive parallel to the black line, a metamaterial has a refractivity of 0.

The incident plane wave is refractive to the right of the reference black line and is emitted. Thus, the metamaterial structure of the present embodiment has the characteristics of negative refractivity.

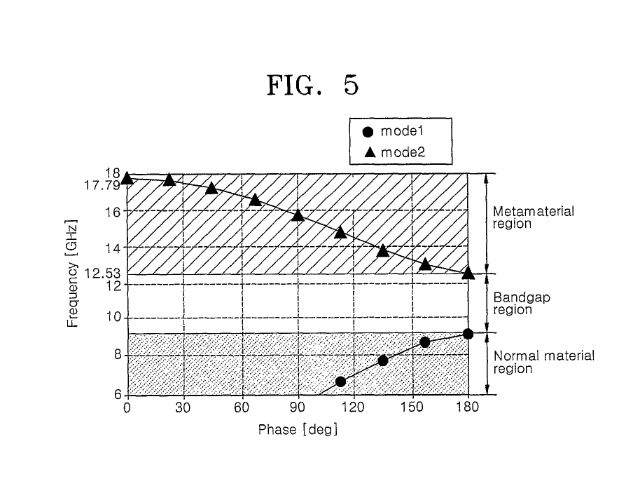

FIG. 5 is a graph illustrating the characteristics of an eigen mode with respect to the metamaterial structure shown in FIG. 3A. Referring to FIG. 5, a value of refractivity of the metamaterial structure is indirectly analyzed by using a result of the eigen mode.

A frequency range between 12.53 GHz and 17.79 GHz is a metamaterial area having a negative refractivity. A frequency range between about 9 GHz and 12.5 GHz is a bandgap region in which an electromagnetic wave does not transmit. A frequency range lower than 9 GHz is a propagation region of a general material having a positive refractivity.

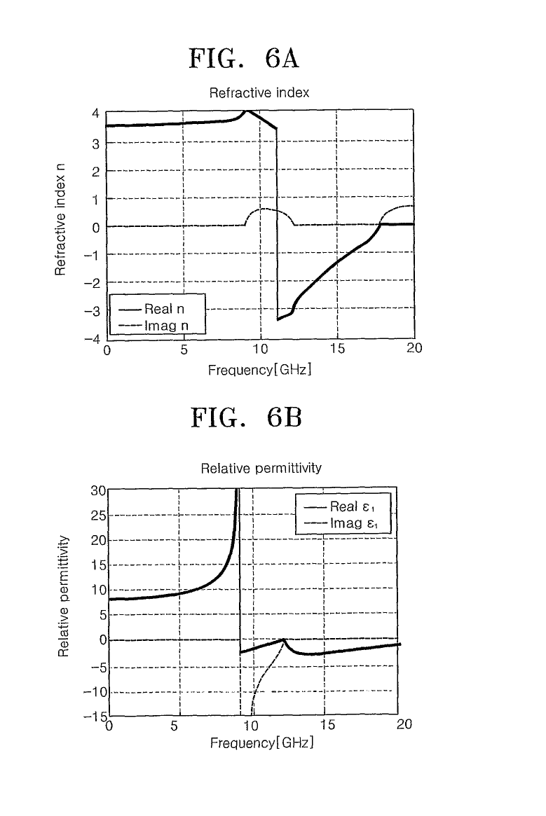

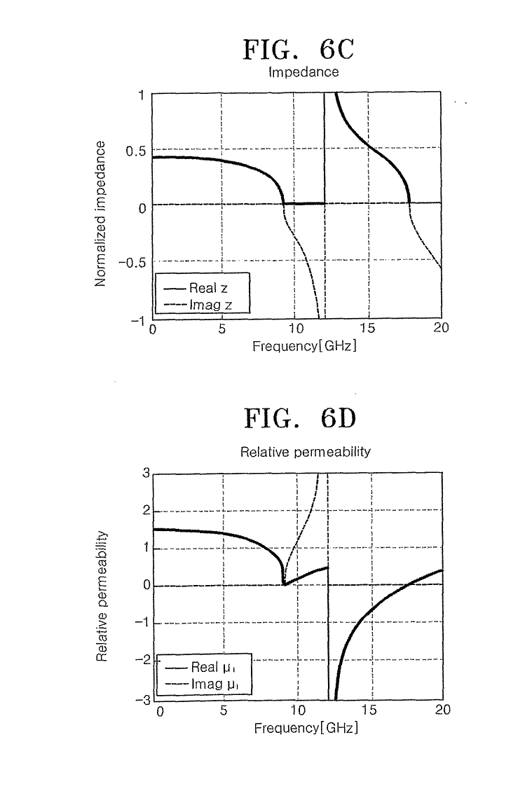

FIGS. 6A through 6D are graphs illustrating electrical characteristic parameters with respect to the metamaterial structure shown in FIG. 3A.

FIG. 6A is a graph of the electrical characteristic in terms of refractivity with respect to the metamaterial structure shown in FIG. 3A. When the graph shown in FIG. 6A is compared to the graph shown in FIG. 5, a frequency band having positive and negative refractivity and a band-gap region of both graphs are identical to each other. In more detail, referring to FIG. 6A, a refractivity of a frequency region has imaginary and real parts that do not have a value 0. The frequency region belongs to a band-gap region. A refractivity of a metamaterial region has a negative real part, i.e., a refractivity of a frequency region between 12.53 GHz and 17.79 GHz has a negative real part.

FIG. 6B is a graph of the electrical characteristic in terms of relative permittivity with respect to the metamaterial structure shown in FIG. 3A. Referring to FIG. 6B, the relative permittivity of a frequency region greater than 9 GHz has a negative real part.

FIG. 6C is a graph of wave impedance with respect to the metamaterial structure shown in FIG. 3A normalized as a free space impedance (=377Ω). Referring to FIG. 6C, an impedance of a band-gap region is 0 as expected.

FIG. 6D is a graph of the electrical characteristic in terms of relative permeability with respect to the metamaterial structure shown in FIG. 3A. Referring to FIG. 6D, the relative permeability of a metamaterial region between 12.53 GHz and 17.79 GHz has a negative real part.

As shown in FIGS. 6B through 6D, the metamaterial structure shown in FIG. 3A has positive permittivity and positive permeability in a section having a positive refractivity, a negative permittivity and a positive permeability in a band-gap region, and negative permittivity and negative permeability in a section having a negative refractivity. Such results are identical to those shown in FIGS. 5 and 6A.

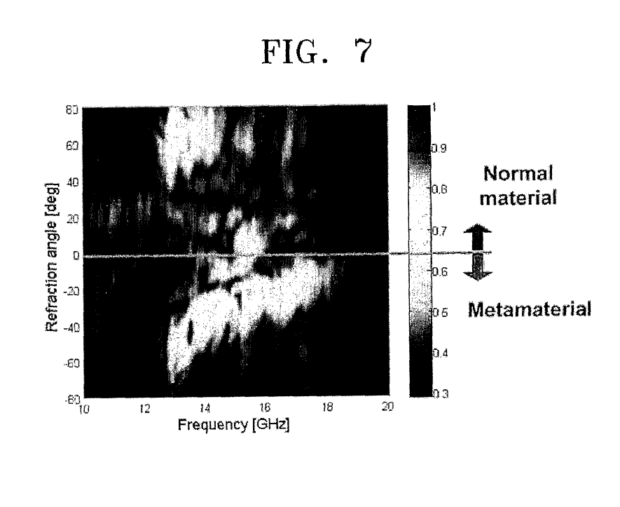

FIG. 7 is another photo of an experiment verifying a negative refractivity with regard to the metamaterial structure shown in FIG. 3A, in which the metamaterial structure substantially has the negative refractivity.

Referring to FIG. 7, the experiment is the same as the computer simulation shown in FIG. 4. A pass characteristic parameter of an electromagnetic wave, i.e., a transmission parameter S₂₁, is normalized to have a maximum value ‘1’ and varies according to frequencies and angles. Most signals are transmitted in a negative direction having a refractive angle smaller than 0, i.e., a negative angle, between about 12.8 GHz and 17.8 GHz. This indicates that the metamaterial structure shown in FIG. 3 in the shape of a wedge formed by stacking metamaterials cells servers as a medium having a negative refractivity. Such a result is identical to the results shown in FIGS. 5 through 6D.

Meanwhile, a weak signal is transmitted in a positive direction, which seems to be due to a scattering phenomenon since a boundary surface of the metamaterial structure formed by stacking the metamaterial cells is angled like stairs.

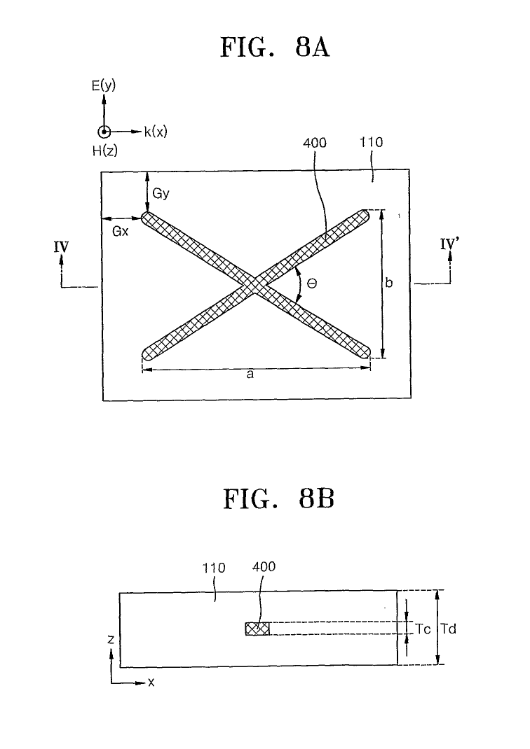

FIGS. 8A and 8B are plan and cross-sectional views, respectively, of a metamaterial structure having a negative permittivity and a negative permeability according to another embodiment of the present invention, based on the metamaterial structure comprising a single conductor as shown in FIG. 1A.

Referring to FIG. 8A, although the structure of a dielectric 110 of the present embodiment is similar to that shown in FIG. 3A, a conductor 400 disposed in the dielectric 110 has a different structure compared to that of the conductor shown in FIG. 3A. In more detail, the conductor 400 has an X-shaped structure, in which a width a, a length b, an angle θ, and distances Gx and Gy by which the conductor 400 is spaced apart from the surfaces of the dielectric 110 are adjusted according to a frequency band. In more detail, each parameter may be adjusted to have a negative permittivity, a negative permeability, and a negative refractivity in a specific frequency region according to a user's intention.

Referring to FIG. 8B, which illustrates a cross-sectional view of the metamaterial structure of FIG. 8A taken along the line IV-IV', the thickness Tc of the conductor 400 and the thickness Td of the dielectric 110 may be adjusted according to a frequency region, and a permittivity of the dielectric 110 may be adjusted.

FIGS. 9A and 9B are plan and cross-sectional views, respectively, of a metamaterial structure having a negative permittivity and a negative permeability according to another embodiment of the present invention, based on FIG. 2A showing two conductors.

Referring to FIG. 9A, two conductors 500 are disposed in a dielectric 110, each conductor 500 having the same structure, in the shape of a long cuboid plate, and facing each other. The two conductors 500 are symmetrical to each other with regard to a center line of the dielectric 110. Thus, the metamaterial structure includes a pair of double plate resonators (DPR).

A width a and a length b of each conductor 500, distances Gx Gy by which each conductor 500 is spaced apart from the surfaces of the dielectric 110 are adjusted according to a frequency band.

Referring to FIG. 9B, which illustrates a cross-sectional view of the metamaterial structure of FIG. 9A taken along the line V-V′, the thickness Tc of each conductor 500 and the thickness Td of the dielectric 110 may be adjusted according to a frequency region, and a permittivity of the dielectric 110 may be adjusted.

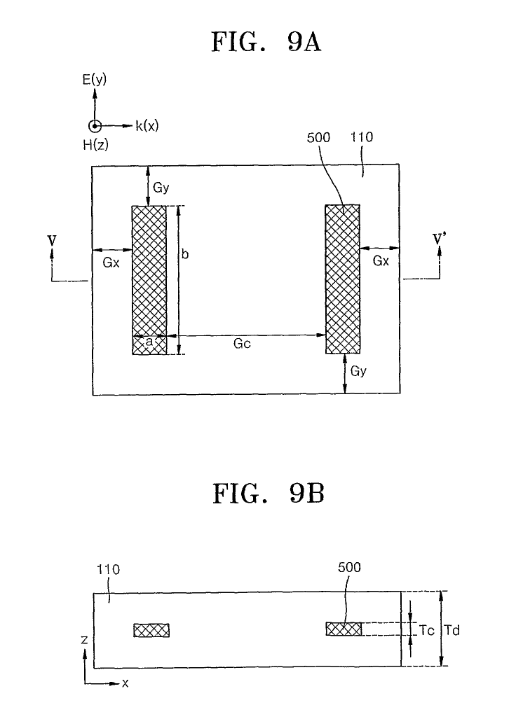

FIGS. 10A and 10B are plan and cross-sectional views, respectively, of a metamaterial structure having a negative permittivity and a negative permeability according to another embodiment of the present invention, based on FIG. 2A showing two conductors.

Referring to FIG. 10A, although two conductors 600 have a more complex structure than the conductors 500 shown in FIG. 9A, the two conductors 600 that are symmetrical to each other and have the same structure are similar to the conductors 500 shown in FIG. 9A. For example, the metamaterial structure shown in FIG. 10A is a cut-cross resonator (CCP) structure.

To be more specific, each conductor 600 has a ribbon type plate structure having a center convex part in an outer direction of a dielectric 110 by folding each conductor 600 four times at right angles. A width w of each conductor 600, a length a and a width c of each convex part of the conductor 600, the upper and lower part lengths b and d of the conductor 600, distances Gx and Gy by which the conductor 600 is spaced apart from the surfaces of the dielectric 110, and a distance Gc by each conductor 600 are spaced apart from one another are adjusted according to a frequency region.

Referring to FIG. 10B, which illustrates a cross-sectional view of the metamaterial structure of FIG. 10A taken along the line VI-VI′, the thickness Tc of each conductor 600 and the thickness Td of the dielectric 110 may be adjusted according to a frequency region, and a permittivity of the dielectric 110 may be adjusted.

The metamaterial structures each including one or two conductors having parameters are described with reference to FIGS. 3A, 8A, 9A, and 10A. The parameters of each metamaterial structure are adjusted to have a negative permittivity, a negative permeability, and a negative refractivity in a frequency region according to a user's intention so that the metamaterial structures can be utilized in a desired electronic device.

FIG. 11 is a perspective view of a metamaterial structure array according to an embodiment of the present invention. Referring to FIG. 11, the metamaterial structure array comprises a plurality of the dielectric sheets 1000, 1000a, and 1000b stacked, and thus the metamaterial array has a relatively large volume. Each of the dielectric sheets 1000, 1000a, and 1000b is properly disposed as a unit cell.

For example, the metamaterial structure array is formed by disposing the conductor 300 shown in FIG. 3A in the dielectric 110 by the regular distances Gx and Gy vertically and horizontally, forming the dielectric sheets 1000, 1000a, and 1000b, and stacking the dielectric sheets 1000, 1000a, and 1000b. The size of each of the dielectric sheets 1000, 1000a, and 1000b is adjusted and the number of conductors disposed in the dielectric sheets 1000, 1000a, and 1000b is adjusted in order to form a wedge or pyramid structure as described with reference to FIG. 4.

Meanwhile, the shape of the conductor 300 disposed in the dielectric sheets 1000, 1000a, and 1000b is not limited to the cuboid shown in FIG. 3A but the conductor having various shapes can be disposed in a predetermined structure.

A user can form a metamaterial structure array suitable for a particular usage purpose by establishing metamaterial structures having various structures as a unit cell and disposing or cutting the metamaterial structures as shown in FIG. 11. The metamaterial structure of the present embodiment has intrinsic characteristics whereby a negative refractivity can be obtained by only using a single cell with reference to FIGS. 3A, 8A, 9A, and 10A, unlike a phonic band gap (PBG) material or an electromagnetic band gap (EBG) material.

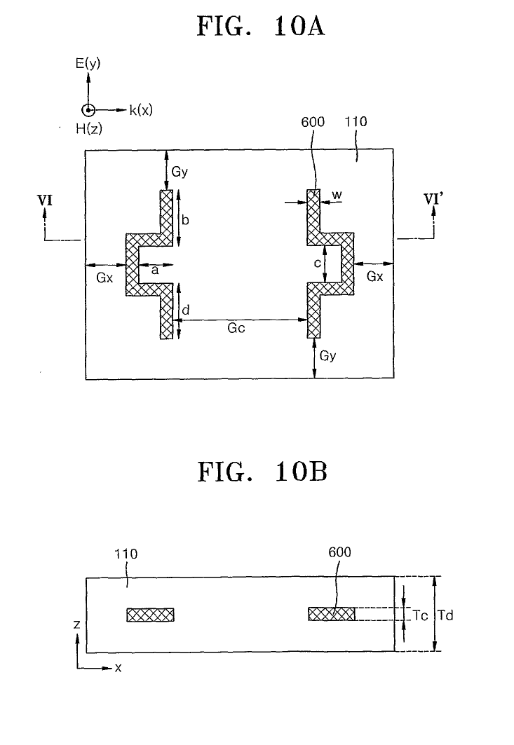

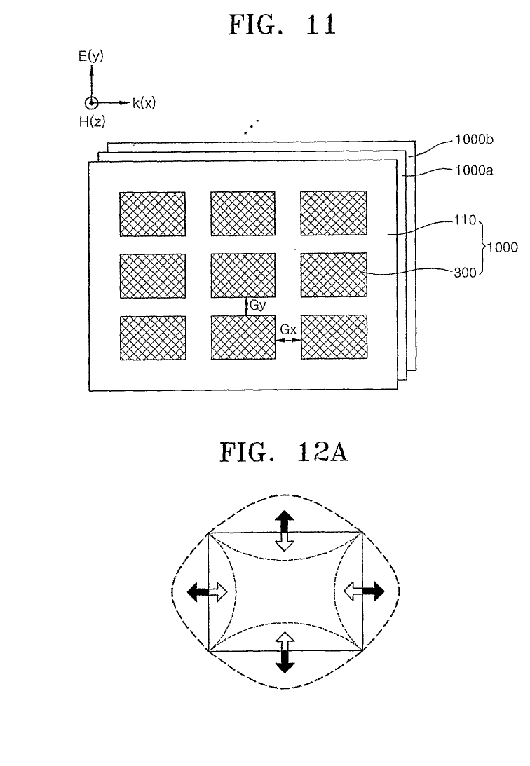

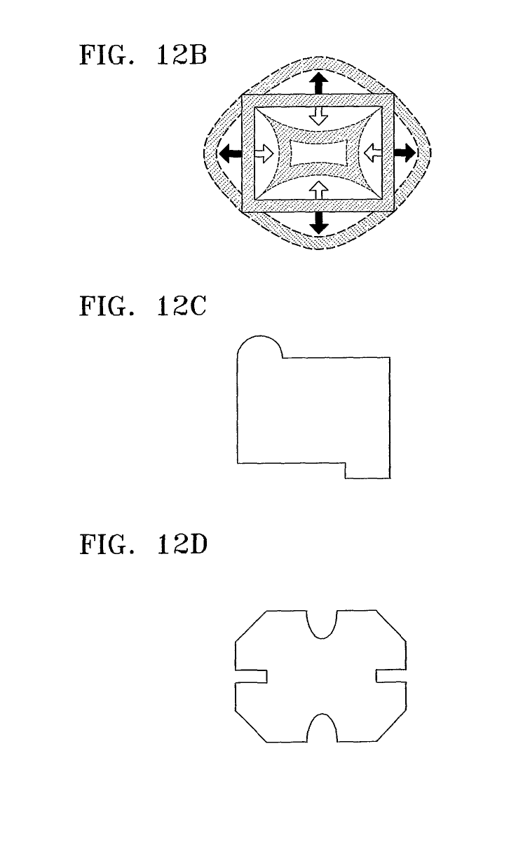

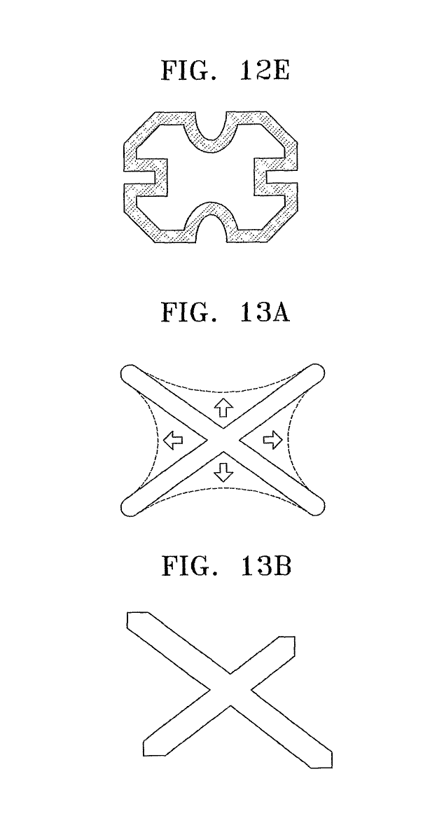

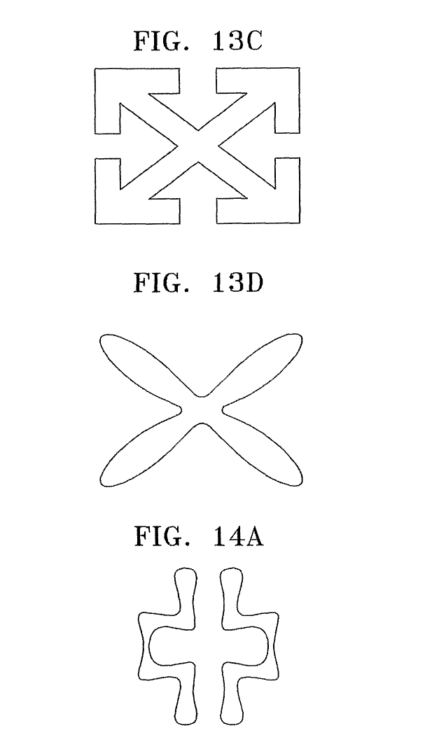

FIGS. 12A through 12E and 13A through 13D are plan views of conductors applied to the metamaterial structure shown in FIG. 1A. Referring to FIG. 12A, a conductor having a cuboid structure extends or reduces in an arrow direction, which shows the possibility of a modification to a geometrical shape of the conductor. Referring to FIG. 12B, a conductor having a cuboid ring structure extends or reduces in an arrow direction, which shows the possibility of various modifications to the conductor structure. Referring to FIGS. 12C through 12E, it is possible to make various modifications to the conductor. A difference between FIGS. 12D and 12E is that the metamaterial structure shown in FIG. 12D is a conductor, whereas the metamaterial structure shown in FIG. 12E includes a conductor corresponding to a ring shape part, which is applied to FIGS. 12A and 12B in the same manner.

Referring to FIG. 13A, an X-shaped conductor extends in an arrow direction, which shows the possibility of various modifications to the X-shaped conductor. Referring to FIG. 13B, X-shaped conductors are not symmetrically formed. Referring to FIGS. 13C and 13D, it is possible to make various modifications to the X-shaped conductor.

Although a single conductor having various structures is described with reference to FIGS. 12A through 12E and 13A through 13D, the present invention is not limited thereto. That is, a conductor having various other structures can be formed.

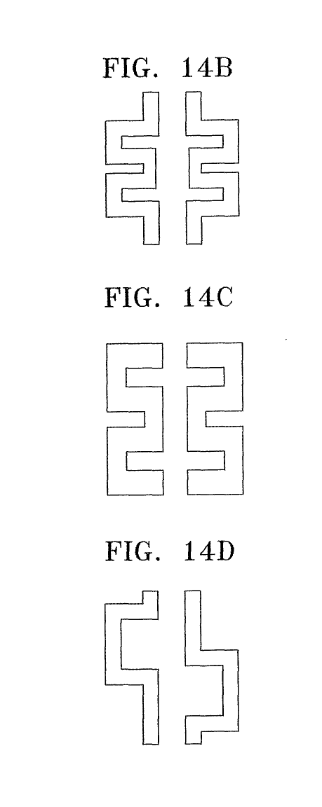

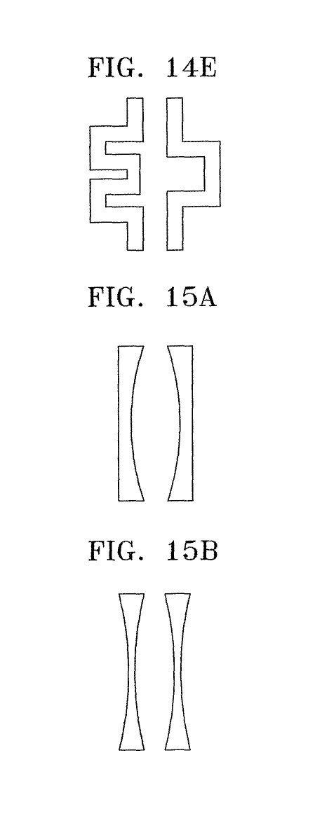

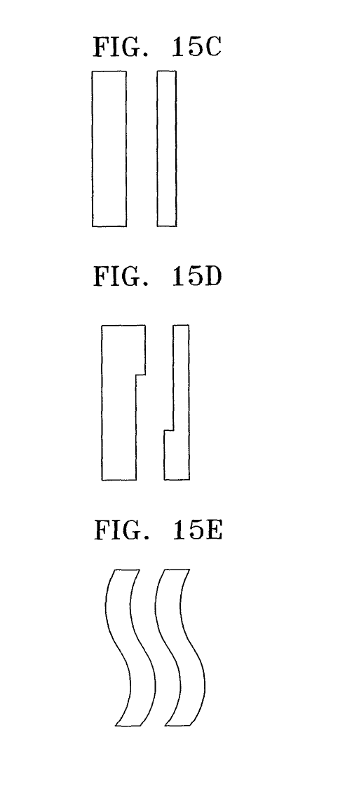

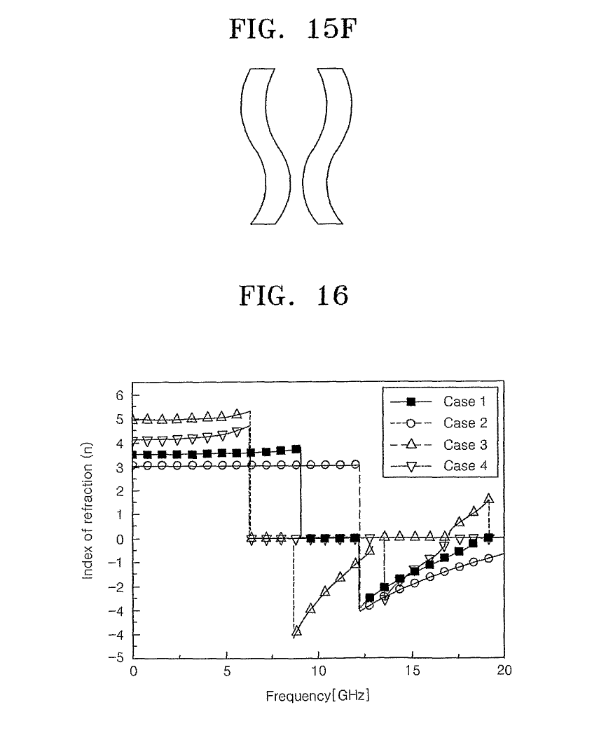

FIGS. 14A through 14E and 15A through 15F are plan views of conductors applied to the metamaterial structure shown in FIG. 2A. Referring to FIG. 14A through 14C, although conductors are similar to those shown in FIG. 10A, the conductors have more complex or various other structures. Referring to FIGS. 14D and 14E, both conductors may not be identical or symmetrical to each other.

Referring to FIGS. 15A through 15F, conductors have various structures that are similar to those shown in FIG. 9A and both conductors are not identical or symmetrical to each other.

Although two conductors having various structures are described with reference to FIGS. 14A through 14E and 15A through 15F, the present invention is not limited thereto. That is, a pair of conductors having various other structures can be formed.

Referring to FIGS. 12A through 15F, the conductor that can be formed in the metamaterial structure may include all structures applicable to the present invention, which are applicable to one of ordinary skill in the art.

FIG. 16 is a graph illustrating an adjustment of a frequency band having a negative refractivity of a metamaterial structure by adjusting each parameter of the SPR metamaterial structures shown in FIGS. 3A and 3B, so that a user can adjust the frequency band region having the negative refractivity.

Table 1 includes design parameters for obtaining the result shown in FIG. 16. The design parameters indicated in Table 1 are shown in FIGS. 3A and 3B.

TABLE

| parameters | | a | b | Gx | Gy | Tc | Td | εr |
|---|---|---|---|---|---|---|---|---|
| length | Case 1 | 3.5 | 2.2 | 0.25 | 0.4 | 0.035 | 0.797 | 9.7 |
| (mm) | Case 2 | 3.5 | 0.22 | 0.25 | 0.4 | 0.035 | 0.797 | 9.7 |
| | Case 3 | 3.5 | 2.2 | 0.25 | 0.4 | 0.035 | 0.797 | 3.88 |
| | Case 4 | 3.5 | 2.2 | 0.25 | 0.04 | 0.035 | 0.797 | 9.7 |

Referring to Table 1, widths a, b in directions x and y of a conductor, distances Gx, and Gy between the conductor and a dielectric surface, the thickness Tc of the conductor, the thickness Td of the dielectric, a permittivity ∈ᵣ of the dielectric, and the like in the SPR metamaterial structure can be used as the design parameters, leading to various variations of a refractivity as shown in the graph of FIG. 16.

Therefore, based on the graph of FIG. 16 and Table 1, a user can also obtain a desired permittivity, permeability, or refractivity value through the variations of the design parameters with regard to the various metamaterial structures shown in FIGS. 8A through 15F.

The metamaterial structure based on a single layer structure can include a conductor and a dielectric, can be a single layer structure, and can obtain permittivity, permeability, and refractivity having a positive value, 0, or a negative value in a desired frequency bandwidth, so that the permittivity, permeability, refractivity, and impedance can be adjusted, thereby controlling a basic physical property such as the size, wavelength, phase, polarization of a signal, etc. in all application fields using an electromagnetic wave according to a user's intention.

The metamaterial structure according to the present invention can be utilized as a source technology in a variety of fields such as, phase compensation of a signal, size reduction and performance improvement of an antenna, a high performance high resolution electronic device for recognizing a subwavelength object in a near-field region, or a far-field region, and a high performance magnetic resonance imaging (MRI) sensor based on a high permeability.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The present invention relates to a metamaterial, and more particularly to, a metamaterial structure having negative refractivity in a natural state and using a general medium such as a conductor and a dielectric. The metamaterial structure based on a single layer structure can include a conductor and a dielectric, can be a single layer structure, and can obtain permittivity, permeability, and refractivity having a positive value, 0, or a negative value in a desired frequency bandwidth, so that the permittivity, permeability, refractivity, and impedance can be adjusted, thereby controlling a basic physical property such as the size, wavelength, phase, polarization of a signal, etc. in all application fields using an electromagnetic wave according to a user's intention.

1. A metamaterial structure comprising:
a dielectric having a single layer structure having a permittivity or a multi-layer structure in which at least one layer has a different permittivity; and
a single conductor disposed in the dielectric,
wherein the metamaterial structure has a permittivity, a permeability, and a refractivity that have 0 or a negative value in a predetermined frequency band.

2. The metamaterial structure of claim 1, wherein the conductor has a plate structure that is horizontally disposed in the dielectric.

3. The metamaterial structure of claim 2, wherein the dielectric has a cuboid structure, and
wherein the conductor has a cuboid plate structure and is disposed a predetermined distance from each surface of the dielectric.

4. The metamaterial structure of claim 1, wherein the conductor has an X-shaped plate structure that is horizontally disposed in the dielectric.

5. The metamaterial structure of claim 1, wherein the conductor has any one of plate structures shown in FIGS. 12A through 13D.

6. The metamaterial structure of claim 1, wherein the dielectric has a multi-layer structure including two or more layers,
wherein the multi layers have a different permittivity.

7. The metamaterial structure of claim 6, wherein the conductor is formed on the same layer as any one of the layers of the dielectric.

8. The metamaterial structure of claim 1, wherein the dielectric has the shape of a cuboid, the conductor has the shape of a plate cuboid and is disposed in the center of the dielectric and parameters widths a, b in directions x and y of a conductor, distances Gx, and Gy between the conductor and a dielectric surface, the thickness Tc of the conductor, the thickness Td of the dielectric, a permittivity ∈ᵣ of the dielectric have a value of any one of cases 1 through 4 shown in [Table 1] of the specification.

9. A metamaterial structure, comprising:
a dielectric having a single layer structure having a permittivity or a multi-layer structure in which at least one layer has a different permittivity; and
at least two conductors disposed in the dielectric on a same plane,
wherein the metamaterial structure has a permittivity, a permeability, and a refractivity that have 0 or a negative value in a predetermined frequency band.

10. The metamaterial structure of claim 9, wherein each of the at least two conductors has a plate structure that is horizontally disposed in the dielectric.

11. The metamaterial structure of claim 9, wherein the number of the conductors is two,
wherein the two conductors have a same or different plate structure.

12. The metamaterial structure of claim 11, wherein the dielectric has a cuboid structure,
wherein the two conductors have a same cuboid plate structure,
wherein each of the two conductors is disposed a predetermined distance from each surface of the dielectric, and is disposed symmetrically to a centerline of the dielectric.

13. The metamaterial structure of claim 11, wherein the dielectric has a cuboid structure,
wherein the two conductors have the same structure comprising a ribbon type plate structure having a predetermined width in which a convex part is formed in the center part of each conductor, the convex part being formed in an outer direction of the dielectric by folding each conductor four times,
wherein each of the two conductors is disposed a predetermined distance from each surface of the dielectric, and is disposed symmetrically to a centerline of the dielectric.

14. The metamaterial structure of claim 9, wherein the dielectric has a multi-layer structure having two or more layers,
wherein each of the layers has at least two permittivities or the layers has different permittivities.

15. The metamaterial structure of claim 14, wherein each conductor is formed on a same layer as any one of the layers of the dielectric.

16. The metamaterial structure of claim 9, wherein the conductor has any one of plate structures shown in FIGS. 14A through 15F.

17. A metamaterial structure array, comprising the metamaterial structure of claim 9 as a single unit cell.

18. The metamaterial structure array of claim 17, wherein a plurality of conductors are upper and lower and left and right disposed in a single dielectric sheet.

19. The metamaterial structure array of claim 18, wherein a plurality of dielectric sheets in which the plurality of conductors are disposed are stacked.

20. The metamaterial structure array of claim 19, wherein the number of the conductors disposed in the dielectric sheets is adjusted to form a wedge or pyramid structure.
